(19) United States
(12) Patent Application Publication
(10) Pub. No.: US 2010/0011655 A1
(43) Pub. Date: Jan. 21, 2010

(54) Flexible glue trap

(76) Inventor: Steven Frisch, Brooklyn, NY (US)

Correspondence Address: BERNARD MALINA, ESQ.;Malina & Associates, PLLC, Suite 501, 60 East 42nd Street, New York, NY, 10165, US

(21) Appl. No.: 12/218,690

(22) Filed: Jul. 17, 2008

(51) Int. Cl. A01M 1/14

(52) U.S. Cl. 43/114

(57) ABSTRACT

A glue trap includes a thin flexible layer of non-drying adhesive is deposited on a substantially flat flexible substrate. Both the adhesive layer and the substrate are of extended length and extremely flexible. The glue trap is provided in roll form and may be mounted in a dispenser which facilitates cutting the glue trap to a desired length at the job site.

### FIELD OF THE INVENTION

The present invention relates generally to the field of rodent control and more particularly, to an extended length flexible glue trap.

### BACKGROUND OF THE INVENTION

The prior art related to glue traps includes examples of traps in which a layer of non-drying glue is disposed on a generally rectangular substrate which includes peripheral flanges and in selected cases, intermediate flanges or ribs disposed between the peripheral flanges. The combination of flanges or ribs results in a substrate which is resistant to bending.

This resistance to bending results in a disadvantage which is inherent in glue traps in the prior art. In cases where a rodent having a foot trapped in a glue layer is able to push down on a flange or rib, the rodent can thus free itself. The rigidity of the substrate enables the rodent to push down on a rib or a flange with enough force to free the trapped foot.

The rectangular structure of the prior art glue traps restricts their use in applications where an extended rodent barrier is required. In such applications, a number of conventional glue traps must be placed end-to-end in an array. This arrangement is both costly and inconvenient. The relatively high cost is a result of the large number of glue traps which must be procured and the inconvenience is a result of placing a relatively large number of glue traps in relatively inaccessible locations such as on the rafters of an agricultural structure, such as a barn or in an industrial factory.

Conventional glue also includes a configuration in which an adhesive is coated on a stiff back surface, either on a board or a plastic tray. The rigidity of the back surface requires a thick layer of adhesive (at least 1/16^{th} of an inch) in order to prevent a rodent from lifting its legs off of the surface or rolling off of the surface, because of the traps' natural resistance to bending.

### OBJECTS AND SUMMARY OF THE INVENTION

It is an object of the present invention to provide an extended length flexible glue trap which includes a relatively thin flexible adhesive layer which is deposited on a thin flexible substrate.

Another object of the present invention is to provide an extended length flexible glue trap in which a flexible substrate which supports a glue layer is substantially flat.

Another object of the present invention is to provide an extended length flexible glue trap in which a thin extremely flexible layer of non-drying adhesive is deposited on a narrow sheet of extremely flexible paper of extended length.

Yet another object of the present invention is to provide an extended length flexible glue trap which can be manufactured in volume resulting in a relatively low unit cost.

Other objects and advantages of the present invention will be apparent hereinafter.

In accordance with the present invention, there is provided an extended length flexible glue trap in which a thin flexible non-drying layer of adhesive is deposited on a flexible flat substrate of extended length.

The adhesive layer may be covered by a release layer which protects the adhesive layer prior to use. The release layer and the substrate are preferably relatively narrow.

The flexible backing allows the trap to move with the rodent. When the rodent attempts to lift its leg off the adhesive surface, the entire trap moves along with the leg. When the rodent attempts to roll off the adhesive surface, the entire trap rolls along with it. This flexible feature allows the use of a thinner layer of adhesive relative to conventional traps while providing a trap of increased efficiency.

In an alternate embodiment of the invention, the flexible glue trap is provided in a roll form without a release layer.

The new flexible trap utilizes a bendable backing which allows the trap to move in synch with the rodent. In other words, in the new style trap, when a rodent attempts to lift its leg off of the surface, the entire trip moves along with the leg, or when the rodent attempts to roll off of the surface, the entire trap rolls along with it. This feature allows the manufacturer to apply less adhesive to the paper while maintaining or increasing the efficacy of the trap.

The trap may be sold in roll form with a preferred 36 traps per roll. A marking is provided approximately every 8″ so that the user will know the suggested size for the trap. The roll is machined to fit a specially made applicator that can be clipped to a pest control operator's utility belt. The applicator features a cutting mechanism which will allow a pest control operator to cut off a trap on the marking every 8″ or roll the paper out even further to customize the trap for a particular situation.

### BRIEF DESCRIPTION OF THE DRAWINGS

Other important objects and advantages of the invention will be apparent from the following detailed description of the invention taken in connection with the accompanying drawings in which:

FIG. 1 is a top plan view of an extended length flexible glue trap made according to the present invention;

FIG. 2 is a side elevation view of the glue trap taken along the line 2-2 of FIG. 1;

FIG. 3 is a perspective view of the glue trap of FIG. 1 shown in a rolled configuration for shipment;

FIG. 4 is a top plan view of an alternative embodiment of the invention which includes a series of perforations;

FIG. 5 is a top plan view of another alternative embodiment of the invention in which the adhesive layer is segmented;

FIG. 6 shows another embodiment of the invention showing another arrangement of the adhesive segments;

FIG. 7 is a top plan view of another embodiment of the invention;

FIG. 8 is a side elevation view of the embodiment of FIG. 7;

FIG. 9 is a top plan view of an individual glue trap of the embodiment of FIG. 1;

FIG. 10 is a side elevation view of the embodiment of FIG. 7 rolled on itself;

FIG. 11 is a perspective view of a dispenser for the embodiment of FIG. 7;

FIG. 12 is a cross-sectional view taken along the line 12-12 of FIG. 11;

FIG. 13 is a cross-sectional view taken along the line 13-13 of FIG. 12;

FIG. 14 is a fragmentary elevation view showing the flexible glue trap of FIG. 1 installed on a vertical structural column;

FIG. 15 is another fragmentary elevation showing the flexible glue trap of FIG. 1 wrapped around a column with an overlap between edges with a portion shown broken away to reveal details of construction; and

FIG. 16 is a fragmentary perspective view of a building structure on which the glue trap of FIG. 1 has been installed.

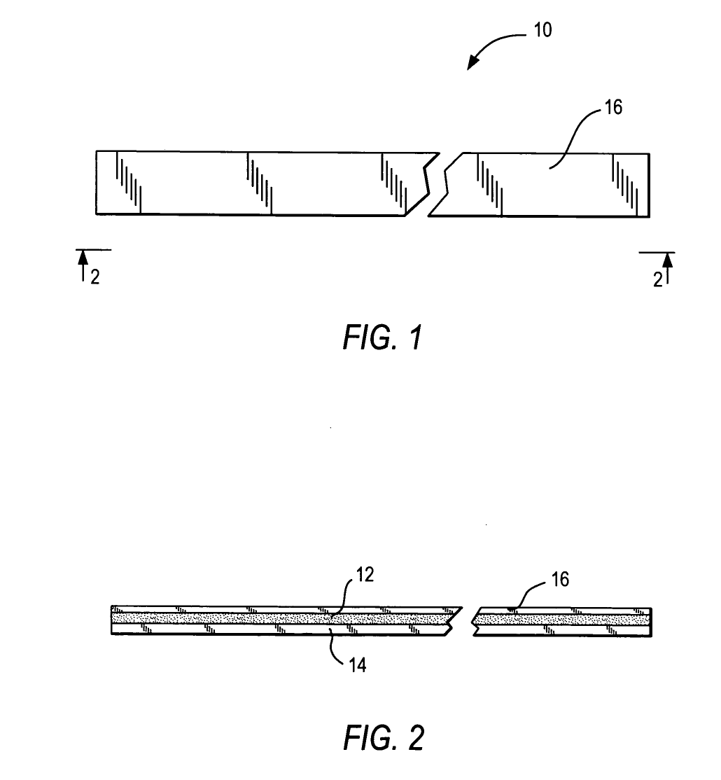

### DETAILED DESCRIPTION OF THE INVENTION

With reference to the drawings, there is shown an extended length flexible glue trap which includes a relatively thin flexible non-drying layer of adhesive 12 which is deposited on a thin substrate 14 of extended length. The substrate 14 is substantially flat.

The adhesive layer 12 is covered by a release layer 16. The release layer 16, the adhesive layer 12, and the substrate 14 are each preferably relatively narrow. The release layer 16 protects the adhesive layer 12 prior to use.

The adhesive layer 12 and the substrate 14 are each extremely flexible.

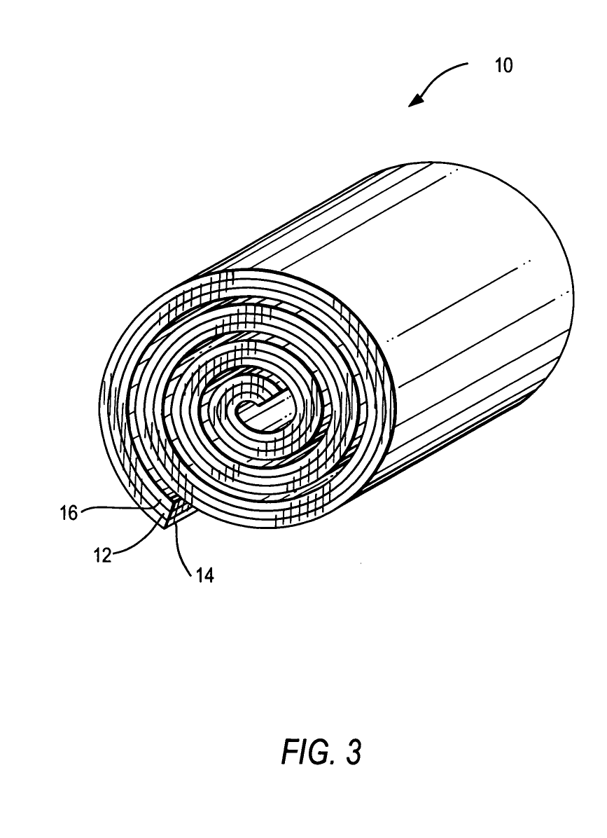

As is shown in FIG. 3 as part of the manufacturing process, the glue trap is rolled for shipment and storage.

During use, the glue trap 10 according to the present invention is unrolled and fastened in place using tacks or small nails. The release layer 16 is removed leaving the non-drying adhesive layer 12 exposed.

When a rodent enters onto the adhesive layer 12 and tries to free itself, the movement of the rodent easily moves the flexible adhesive layer 12 and the flexible substrate 14. The rodent does not have a leverage point to help free itself. The rodent thus remains trapped on the adhesive layer 12.

The elongated length of the glue trap 10 enables the glue trap 10 to be easily mounted on the narrow rafters of a barn or a factory or another structure. The extreme flexibility of the adhesive layer 12 and the substrate 14 enables the glue trap 10 to be placed along the intersection between the floor and the wall of a factory or along an apparent rodent path. The extreme flexibility of the glue trap 10 allows the glue trap 10 to be placed in a manner which follows a curved path. The glue trap 10 may be bent or folded to fit around corners.

The substrate 14 is preferably made of flexible paper or flexible plastic film. The glue trap 10 can be easily cut to a desired length using a pair of scissors or a knife.

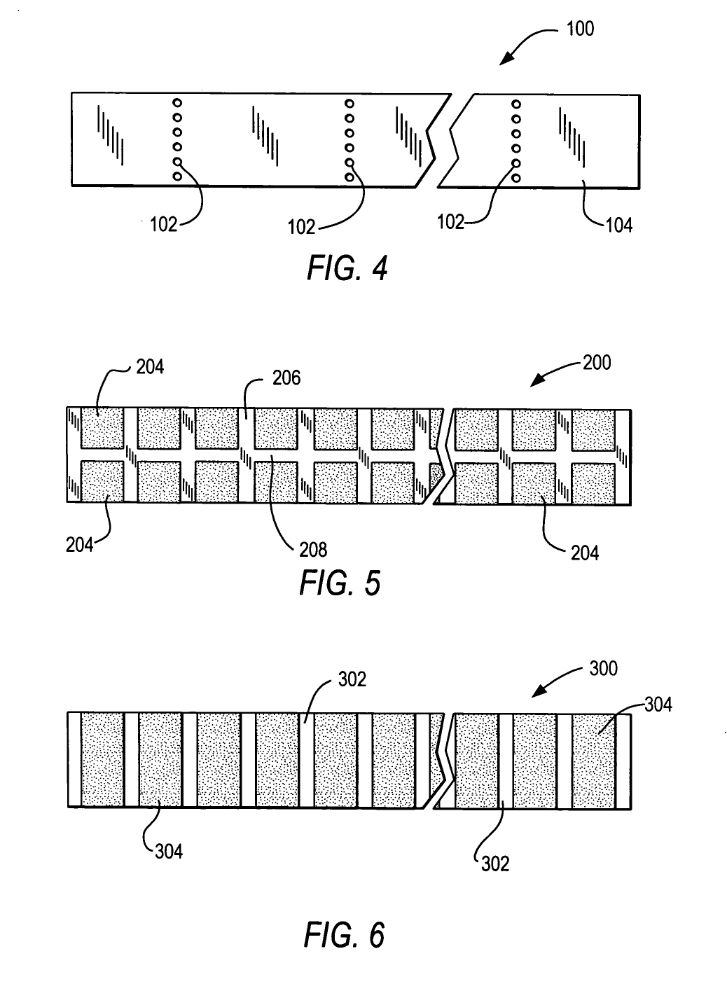

In an alternative embodiment of the invention shown in FIG. 4, the glue trap 100 includes a plurality of rows of perforations 102 which enables the glue trap 100 to be easily torn along the perforations 102 in order to fit the glue trap 100 in a desired location.

As is best shown in FIG. 4, the rows of perforations are disposed transversely relative to the longitudinal axis of the glue trap 100. The glue trap 100 includes a release layer 104, an adhesive layer and a substrate as previously described.

In another alternative embodiment of the invention 200 shown in FIG. 5, the adhesive layer 202 is formed as a series of discontinuous segments 204. The discontinuities 206, 208 between the adhesive segments 204 provides an additional degree of flexibility. This extreme flexibility makes it extremely difficult for a rodent to free itself from the glue trap 200 while facilitating the efficient manufacture. The glue trap 200 also includes a release layer as previously described. The segments 204 may be formed with the discontinuities 206, 208 as shown in FIG. 5 or alternatively, in the embodiment 300 as shown in FIG. 6. The longitudinally oriented discontinuities 208 may be eliminated leaving only the transversely oriented discontinuities 302 and transversely oriented adhesive segments 304.

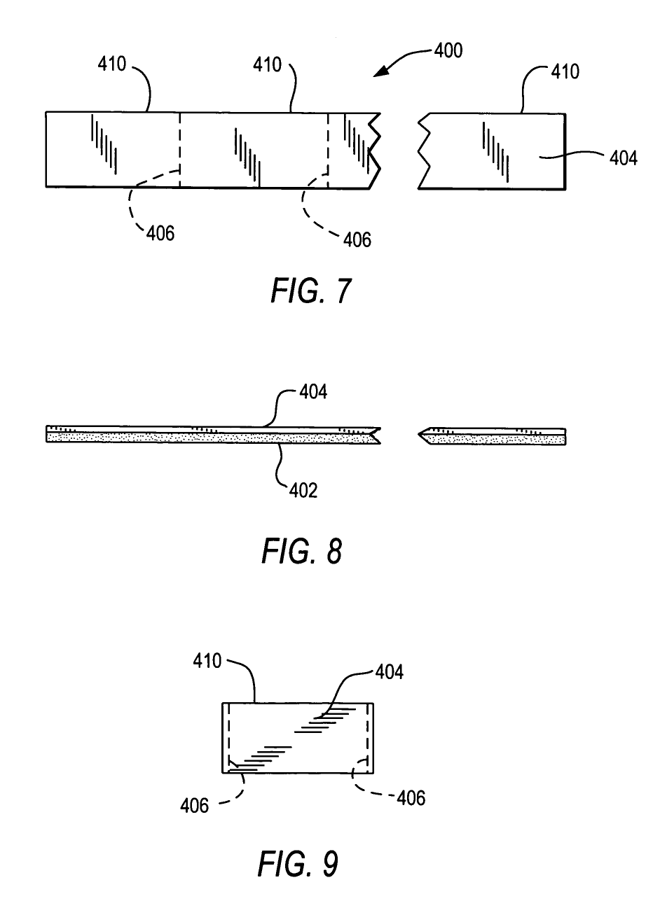

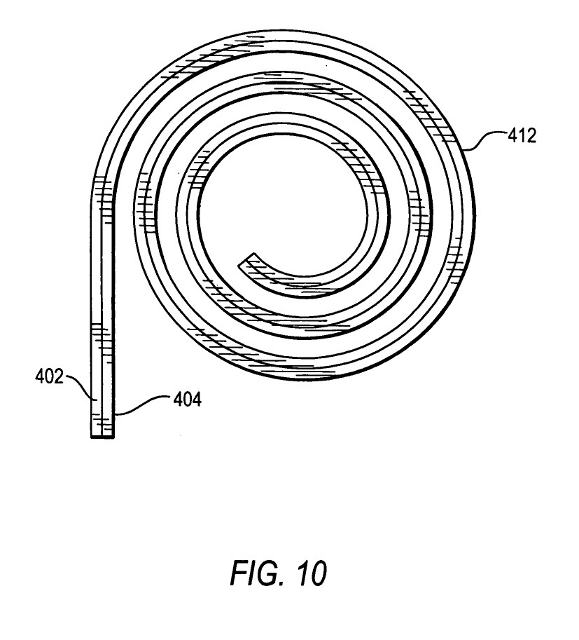

In another embodiment of the invention shown in FIGS. 7-10, the flexible glue trap includes a flexible backing 402 of extended length and a relatively thin layer 404 of non-drying adhesive which is deposited on the backing 402.

The backing 402 is preferably made of a thin flexible paper which can easily be torn in a manner which will be presently described. The backing 402 includes a plurality of spaced apart indicia 406 which may be in the form of broken lines or similar indicia which indicate a preferred length for an individual flexible glue trap 410 as shown in FIG. 7. A preferred spacing for the indicia 406 is in the order of eight inches. The indicia 406 are visible through the non-drying flexible adhesive layer 404 which is transparent or translucent.

Alternatively, the indicia 406 may be formed on the surface 408 of the adhesive 404. The glue trap 400 is manufactured and sold in a roll form 412 in which the glue trap is rolled on itself as is best shown in FIG. 10. A preferred quantity of glue traps 410 per roll 412 is 36. However, a larger or smaller number of glue traps 410 per roll 412 may be utilized.

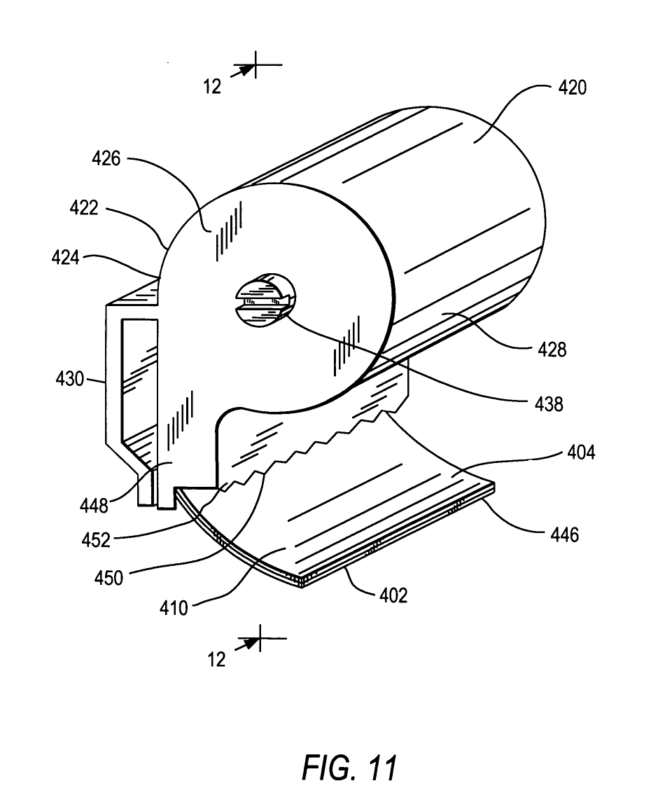

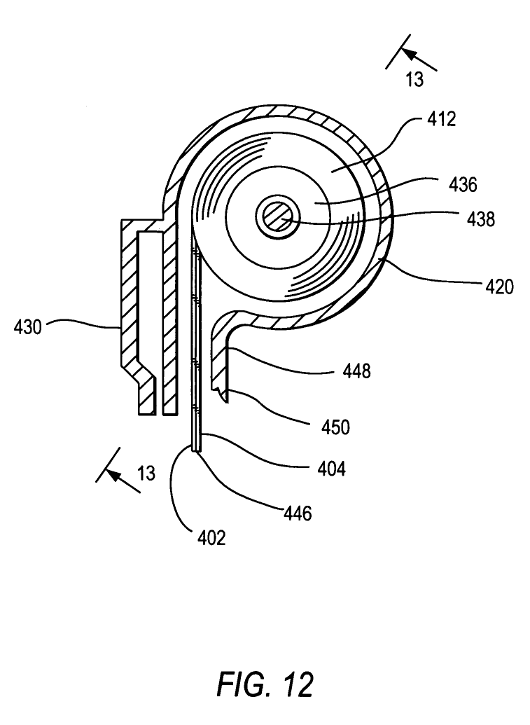

FIGS. 11-13 shows the roll 412 of glue traps 410 stored within a belt mounted dispenser or applicator 420.

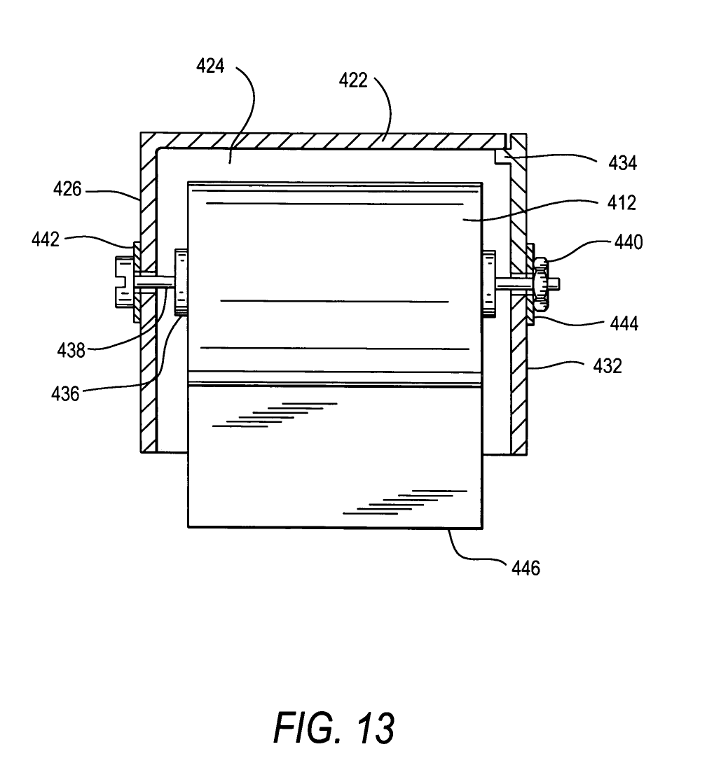

The applicator 420 includes a base member 422 which has an integrally formed back portion 424, first side portion 426 and a front portion 428. The back portion 424 includes a belt clip 430 which enables a pest control operator to mount the applicator 420 on his or her belt for ease of use at a job site. The applicator 420 also includes a removable second side member 432 which includes integrally formed flange portion 434 which fits the base member 422 as is shown in FIG. 13. The fit between the removable second side portion and the back and front portions 424, 428 may be a snap fit or a close tolerance fit.

The roll 412 of flexible glue traps 410 is mounted on a spindle 436 which is rotatably supported by a bolt 438 and nut 440 and washers 442, 444 which connect the base member 422 and the removable second side 432.

The end 446 of the roll 412 flexible glue traps 410 passes through a tubular portion 448 and extended past a row of teeth 450 which are formed on the edge 452 of the tubular portion 448.

During use, the pest control operator grasps the end 446 of the glue trap 410 and withdraws a portion of desired length in accordance with the use environment. The row of teeth 450 allows the pest control operator to cut the glue trap 400 to a desired length. This selected length may be in the order of eight inches as indicated by the indicia 406 or it may be longer or shorter as desired. This enables the pest control operator to customize the flexible glue trap 400 for a particular situation.

The flexible backing allows the trap 400 to move with the rodent. When the rodent attempts to lift its leg off the adhesive surface, the entire trap moves along with the leg. When the rodent attempts to roll off the adhesive surface, the entire trap 400 rolls along with it. This flexible feature allows the use of a thinner layer of adhesive relative to conventional traps while providing a trap of increased efficiency. The preferred thickness of adhesive is in the range of 0.002 inches to 0.06 inches.

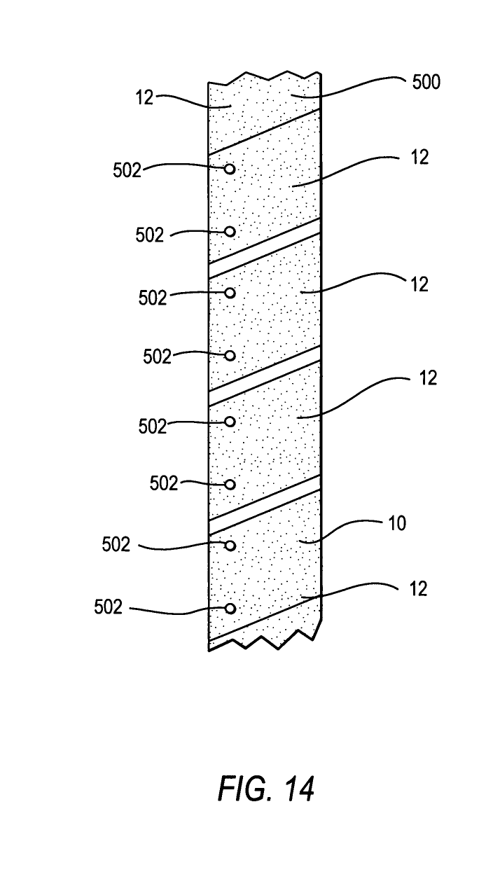

FIG. 14 is a fragmentary elevation view showing the flexible glue trap 10 according to the invention wrapped around a vertical column 500 in a building. A plurality of fasteners such as the nails 502 holds the flexible glue trap 10 in place. Staples or other types of conventional fasteners may be used to hold the flexible glue trap 10 in place.

While FIG. 14 shows the flexible glue trap 10 wrapped around a generally vertical column, it should be understood that the flexible glue trap 10 may be mounted on a horizontal or an inclined member, or a member with irregular, curved or non-planar surfaces.

The thin layer of non-drying adhesive 12 eliminates the problem of sagging or running of the adhesive which would be present if a conventional glue trap having a thick layer of adhesive was used in a vertical orientation.

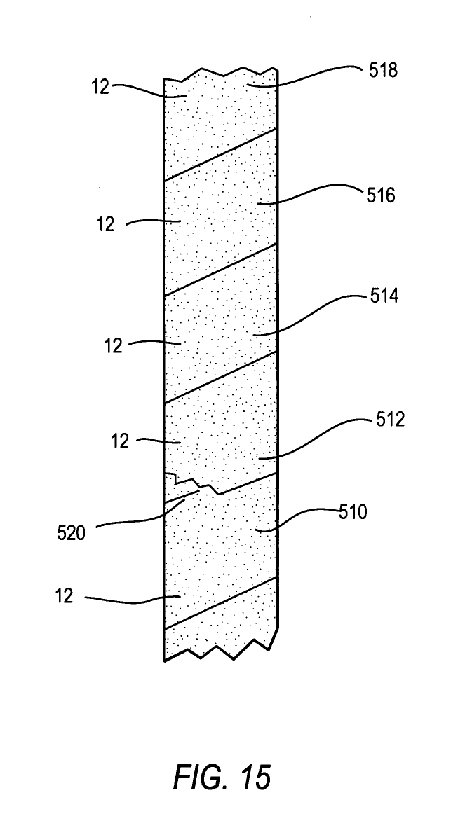

FIG. 15 shows the flexible glue trap 10 wrapped around a column 500 as previously described. In FIG. 15, the successive wrappings 510, 512, 514, 516, 518 have been placed with a slight overlap. This arrangement eliminates or reduces the need for the fasteners as previously described. The overlap area 520 is shown typically in connection with the wrap portion 510 and the wrap portion 512.

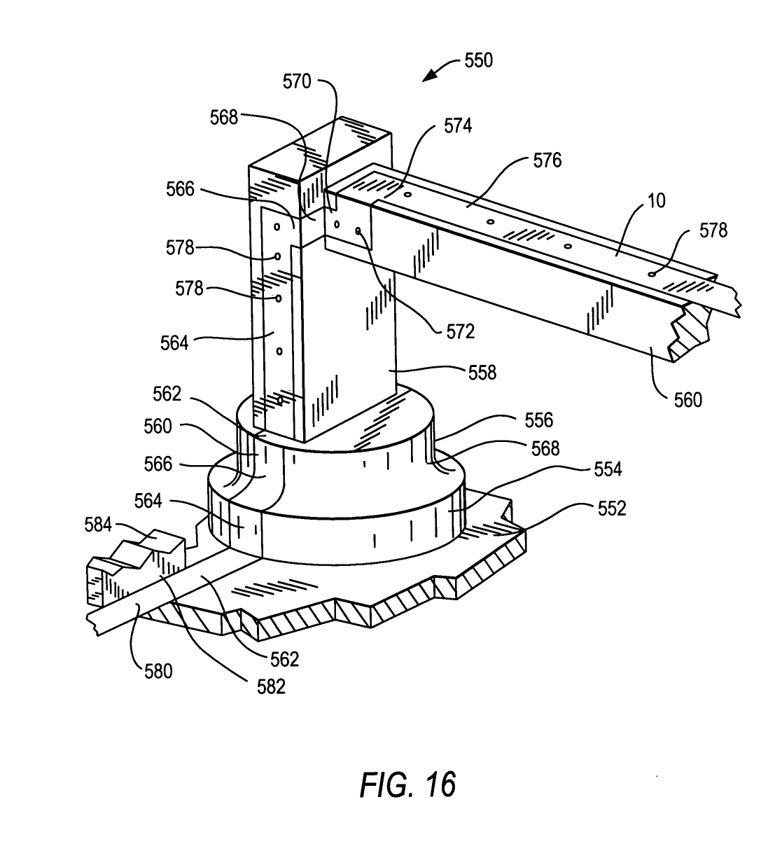

FIG. 16 shows a portion of a building or structure 550 which includes a floor 552, a first footing 554, a second footing 556, a column 558 and a beam 560. A flexible glue trap 10 according to the present invention is mounted on the structure 500 as follows. The flexible construction of the glue trap 10 allows the extended length of the flexible glue trap 10 to provide effective protection against rodents. The use of conventional glue traps to provide equivalent protection would require the purchase of a relatively large number of traps and would result in difficulty in attaching the conventional trap to the structure 550. The flexible structure of the flexible glue trap 10 according to the present invention allows the glue trap 10 to be placed in direct contact with the building structure 550. As shown in FIG. 16, the first portion 562 of the flexible glue trap 10 is disposed on the floor 552, the second 564, and third 566 portion are on the first footing 552.

The portion 566 is on the irregular or curved portion 568. The fourth portion 560 and fifth portions 562 are on the second footing 556. The sixth 564, seventh 566, and eighth 568 portions are on the column 558 and the ninth 570, tenth 572, eleventh 574, and twelfth 576 portion are on the beam 560. The flexible glue trap 10 is attached to the column 558 and the beam 560 by the nails 578.

The portion 580 of the glue trap 10 is disposed at the intersection 582 between the wall 584 and the floor 552.

As illustrated, the flexibility of the glue trap 10 enables the glue trap to be placed in contact with flat, irregular, curved, vertical, horizontal, and multi-planar surfaces.

The foregoing specific embodiments of the present invention as set forth in the specification herein are for illustrative purposes only. Various deviations and modifications may be made within the spirit and scope of this invention, without departing from a main theme thereof.

What is claimed is:

1. An extended length flexible glue trap comprising:
an elongated flexible substrate; and
a flexible layer of non-drying adhesive deposited on said flexible substrate.

2. The extended length flexible glue trap as claimed in claim 1 wherein said flexible substrate comprises a paper substrate.

3. The extended length flexible glue trap as claimed in claim 1 wherein said flexible layer of non-drying adhesive comprises a thin layer.

4. The extended length flexible adhesive glue trap as claimed in claim 1 wherein said flexible substrate comprises a plastic substrate.

5. The extended length flexible adhesive glue trap further comprising a plurality of rows of perforations disposed transversely relative to said elongated flexible substrate and said flexible layer of adhesive.

6. The extended length flexible adhesive glue trap as claimed in claim 1 wherein said flexible layer of non-drying adhesive is deposited in a segmented array.

7. The extended length flexible adhesive glue trap as claimed in claim 1 wherein said substrate includes a plurality of generally equally spaced indicia.

8. The extended length flexible adhesive glue trap as claimed in claim 1 wherein said substrate includes a plurality of rows of perforations.

9. The extended length flexible adhesive glue trap as claimed in claim 1 wherein the glue trap is in a roll form with said glue trap rolled on itself.

10. A flexible glue trap dispenser comprising;
a housing;
a roller rotatably mounted in said housing;
a roll of flexible glue trap of extended length disposed wound on said roller, and
a plurality of teeth formed on said housing for cutting said flexible glue trap to a desired length.

11. The extended length flexible glue trap as claimed in claim 1 wherein said flexible layer of non-drying adhesive has a preferred thickness in the range of 0.002 inches to 0.06 inches.

12. A method for trapping rodents comprising the steps of:
providing an extended length of flexible paper;
depositing a layer of non-drying adhesive on said flexible paper;
cutting said combination of flexible paper and layer of non-drying adhesive to a selected length, and
placing said selected length of flexible paper and non-drying adhesive with said non-drying adhesive upwardly disposed on a selected surface for the purpose of trapping rodents.

13. A method for trapping rodents comprising the steps of:
providing an extended length of flexible paper having a first and a second surface and thin layer of non-drying adhesive deposited on said first surface;
placing said second surface of said flexible paper in direct contact with a selected surface.

14. The method for trapping rodents as claimed in claim 13 wherein said selected surface comprises an irregular surface.

15. The method for trapping rodents as claimed in claim 13 wherein said selected surface comprises a curved surface.

16. The method for trapping rodents as claimed in claim 13 wherein said selected surface comprises a multi-planar surface.

17. The method for trapping rodents as claimed in claim 13 wherein said selected surface comprises a non-planar surface.

18. The method for trapping rodents as claimed in claim 13 wherein said selected surface comprises a vertical surface.

19. The method for trapping rodents comprising the steps of:
providing an extended length of flexible paper having a thin layer of non-drying adhesive;
wrapping said extended length of flexible paper around a member with said thin layer of non-drying adhesive facing outwardly relative to said member.

20. The method for trapping rodents as claimed in claim 13 after said step of placing said second surface of said flexible paper in direct contact with a selected surface further comprising the step of attaching said extended length of flexible paper to said selected surface using a plurality of nails.

21. The method for trapping rodents as claimed in claim 19 wherein said step of wrapping said extended length of flexible paper around a member with said thin layer of non-drying adhesive facing outwardly relative to said member further comprises wrapping said extended length of flexible paper around a member, forming a plurality of turns with a partial overlap of successive turns of said flexible paper.
